(19) United States
(12) Patent Application Publication
(10) Pub. No.: US 2003/0125941 A1
(43) Pub. Date: Jul. 3, 2003

(54) Method for creating a data structure, in particular of phonetic transcriptions for a voice-controlled navigation system

(76) Inventors: Ulrich Gaertner, Nordstemmen (DE); Katja Kunitz, Braunschweig (DE)

Correspondence Address: KENYON & KENYON, ONE BROADWAY, NEW YORK, NY, 10004, US

(21) Appl. No.: 10/256,396

(22) Filed: Sep. 27, 2002

(30) Foreign Application Priority Data
Sep. 27, 2001 (DE) 101 47 734.1

(51) Int. Cl. G06F 7/00

(52) U.S. Cl. 704/231; 707/102

(57) ABSTRACT

A method for recognizing a voice input, in particular of a spoken description, such as a place name, where, from a voice input, a voice signal is generated; from a total set of phonetic transcriptions, subsets are created, whose elements each fulfill one criterion; by intersecting the subsets, a cut set is created, whose element number does not exceed a predefined comparison value; the elements of this cut set are compared to the voice signal; and, given a phonetic similarity with one of the elements of the cut set, the voice signal is allocated thereto. Also described is a device for this purpose. The method and device described herein permit a voice input to be recognized and allocated to a geographic designation, without the need for any manual operation.

### FIELD OF THE INVENTION

The present invention relates to a method for creating a data structure, in particular of phonetic transcriptions for a voice-controlled navigation system, as well as to a method and a device for recognizing a voice input utilizing such a method.

### BACKGROUND INFORMATION

Typically, vehicle navigation systems use a list of preselected place names that the driver can access for purposes of entering the intended destination. Generally, the destination is entered exclusively manually. Place and street names are entered letter for letter via key input. In the process, a word that is begun can be compared to the list of preselected place names and, if indicated, be automatically completed.

The manual input makes it possible for the place name in question to be precisely entered, so that, in principle, a large number of different place names can be prestored. However, the manual inputting is labor-intensive and can adversely affect the driver's attentiveness.

### SUMMARY OF THE INVENTION

In contrast, the method in accordance with the present invention and the device in accordance with the present invention have the particular advantage of allowing a voice input to be recognized and of enabling an allocation to be made to a geographic designation, without involving any manual operation.

In accordance with the present invention, a set having a limitable number of elements may be created by selecting suitable criteria which are used to create subsets and subsequently to create cut sets.

As a result, particularly in the context of a navigation system, a conventional voice-comparison device, i.e., a typical voice recognition unit may be used, which has an active memory for comparing the voice input to a limited comparison number of phonetic transcriptions. However, the size of the total usable set is not limited by this comparison number, since the subsets are created by criteria. The result is that a high level of user friendliness may be provided, even when the selection is made among a large number of place names. Generally, the criteria are appropriately selected in the operating concept.

In accordance with the present invention, besides place names, other designations, in particular names of districts, road designations, and places of interest may also be recognized.

Various criteria types may be used for the criteria. Subsets, which may be disjoint or non-disjoint, are created for the various criteria types. Examples of criteria types are: the first digits of the zip code, the proximity to a relatively large city, the region or the state, the population figure or the administrative classification. In this context, the criteria each relate to the names designated by the phonetic transcriptions.

A criterion is applied to create a first-generation subset out of the total set. The subset includes all locations which meet this criterion, for example, the criterion “zip code begins with the digits 33”. A plurality of criteria are able to be used by intersecting a plurality of subsets. In this connection, a subset of the k-th generation is achieved by intersecting k first-generation subsets.

In accordance with their size or element number, the subsets may be subdivided into classes, each having element numbers between two natural numbers of a numerical sequence n1, n2, n3, . . . , where n1<n2<n3< . . . A set, for whose element number m, it holds that nₖ₋₁<m<nₖ, is designated as a set from level k. In this context, n₀=0.

In accordance with the present invention, it is true for one that, starting out from an initial set of any class and generation, the size or element number may be reduced by adding further criteria. According to this concept, an initial set of any generation and class may be reduced.

Furthermore, without an initial set, criteria may be suitably combined. In this manner, a subset may be obtained, for example, which includes all locations which fulfill a desired combination of k criteria. In this connection, the corresponding subset of the first generation is formed, the class of the individual subsets being unimportant. The cut set is then formed from these subsets. By properly choosing the criteria, one is able to define the size of the cut set.

### BRIEF DESCRIPTION OF THE DRAWINGS

FIG. 1 shows a representation of subsets created using a method according to the present invention, applying a combination of criteria.

FIG. 2 shows a block diagram of a device in accordance with a specific embodiment of the present invention.

### DETAILED DESCRIPTION

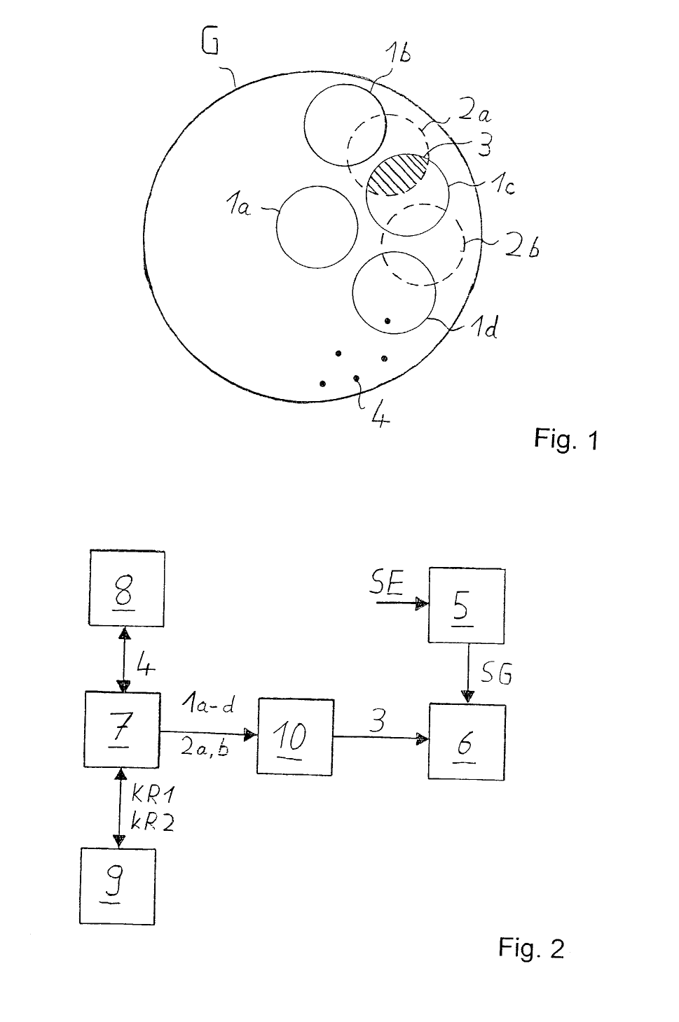

A total set G shown in FIG. 1 includes approximately 80,000 merely partially drawn phonetic transcriptions 4, which relate to various place names. In this connection, differences in the pronunciation of the place names may be taken into consideration, so that, to some extent, a plurality of phonetic transcriptions 4 may refer to one place name.

As a first criterion type, the first two digits of the zip code of the location in question are used. Corresponding first criteria of this first criterion type define subsets 1a, 1b, 1c, 1d, etc. of the first generation on total set G. In this case, for example, subsets 1a, 1b and 1c may correspond to the first criteria “zip code of the location begins with 33”, “zip code of the location begins with 34” and “zip code of the location begins with 38”, and include those phonetic transcriptions 4 as elements, which refer to corresponding place names. In addition, even a subset that is not shown, for example, “zip code of the known location begins with 33 or 34 or 38” may be selected. As a second criterion type, the population figure is used. In this instance, for example, the criterion “population figure between 200,000 and 500,000” defines subset 2a of the first generation, and the criterion “population figure between 500,000 and 1,000,000” defines subset 2b of the first generation.

Intersecting 2a and 1c yields a second-generation subset, which is drawn in as a shaded cut set 3 and, thus, includes the locations whose zip code begins with digits 38 and whose population figure is between 200,000 and 500,000, such as the city of Braunschweig, for example.

In accordance with FIG. 2, in the context of the voice recognition, voice input VI is fed to a voice input device 5, for example a microphone, which outputs a voice signal VS to a voice comparison device 6. In addition, a selection device 7 chooses criteria KR1, KR2 from a criterion memory 9 and the corresponding phonetic transcriptions 4 from a transcription memory 8, such as a CD, and, from this, creates subsets 1a-d and 2a,b. From these subsets, computing device 10 derives cut set CS. Voice-comparison device 6 compares the phonetic transcriptions of cut set CS to voice signal VS, a probability of agreement being able to be determined, and voice signal VS being able to be allocated to a phonetic transcription 4 in response to the exceeding of a predefined probability value.

What is claimed is:

1. A method for creating a data structure, comprising:
creating from a total set of data a plurality of subsets that include elements, each element meeting at least one criterion; and
creating a cut set by intersecting the subsets, wherein an element number of the cut set does not exceed a predefined comparison value.

2. The method as recited in claim 1, wherein:
the data structure includes a phonetic transcription for a voice-controlled navigation system.

3. The method as recited in claim 1, wherein each of the at least one criterion corresponds to a respective one of a plurality of criteria types.

4. The method as recited in claim 1, further comprising:
starting out from an initial set having an element number exceeding the predefined comparison value, selecting k-1 criteria; and
creating and intersecting k-1 subsets that meet the at least one criterion with an initial set, wherein k is ≧2.

5. The method as recited in claim 1, further comprising:
starting out from a total set, selecting k criteria; and
forming and intersecting with each other k subsets that meet the k criteria, wherein k is ≧2.

6. The method as recited in claim 5, further comprising:
selecting a sequence of ascending natural numbers that define classes of subsets, wherein element numbers of each of the k subsets lie between two successive numbers of the sequence, wherein the sequence is selected such that the cut set is created by intersecting the k subsets, wherein the element numbers of the k subsets each lies between the k-1-th and k-th number of the sequence.

7. A method for recognizing a voice input, comprising:
creating a data structure of phonetic transcriptions by:
creating from a total set of data a plurality of subsets that include elements, each element meeting at least one criterion, and
creating a cut set by intersecting the subsets, wherein an element number of the cut set does not exceed a predefined comparison value;
generating a voice signal from the voice input;
comparing elements of the cut set created by the intersecting subsets to the voice signal; and
given a phonetic similarity with one of the elements of the cut set, allocating the voice signal thereto.

8. The method as recited in claim 7, wherein:
the voice input includes a spoken description.

9. The method as recited in claim 7, wherein:
the at least one criterion is entered via voice input.

10. The method as recited in claim 7, wherein:
some of the phonetic transcriptions of a total set correspond to a common designation.

11. The method as recited in claim 7, wherein:
criteria types include at least one of a zip code of a location, a geographic proximity of the location to another location, a geographic region surrounding the location, and a population figure of the location.

12. A device for recognizing a voice input, comprising:
a voice-input device for recording the voice input and for outputting a voice signal;
a selecting device for selecting subsets, each element of which fulfills at least one criterion from a total set of phonetic transcriptions;
a computing device for creating at least one cut set from the subsets, wherein:
an element number of the at least one cut set does not exceed a predefined comparison value; and
a voice-comparison device for comparing elements of the at least one cut set to the voice signal and for allocating the voice signal, given a phonetic similarity, to one of the elements of the cut set.

13. The device as recited in claim 12, wherein:
the voice input includes a spoken geographic description including a place name.

14. The device as recited in claim 12, further comprising:
a transcription memory in which the phonetic transcriptions are stored.

15. The device as recited in claim 12, further comprising:
a criteria memory in which the at least one criterion is stored.

16. The device as recited in claim 12, wherein:
some of the phonetic transcriptions of the total set relate to a common designation.

17. The device as recited in claim 12, wherein:
the at least one criterion of various criteria types is usable.

18. The device as recited in claim 12,
starting out from an initial set having an element number exceeding the predefined comparison value, causing the selecting device to select k-1 criteria and create k-1 subsets from the k-1 criteria; and
causing the computing device to intersect the k-1 subsets with an initial set to form a cutout, wherein k is ≧2.

19. The device as recited in claim 12, further comprising:
starting out from the total set, causing the selecting device to select k criteria; and
causing the computing device to form and intersect with each other k subsets to form a cut set, wherein k is ≧2.
